(19) United States
(12) Patent Application Publication
(10) Pub. No.: US 2015/0279504 A1
(43) Pub. Date: Oct. 1, 2015

(54) FILM FORMING COMPOSITION COMPRISING GRAPHENE MATERIAL AND CONDUCTING POLYMER

(71) Applicant: SOLVAY SA, Bruxelles (BE)

(72) Inventors: Pascal Viville, Ham-Sur-Heure (BE); Victor Soloukhin, Geldrop (NL); Eric Khousakoun, St. Saulve (FR); Nicolas Deligne, Wavre (BE); Severine Coppee, Binche (BE); Eusebiu Grivei, La Hulpe (BE); Roberto Lazzaroni, Floriffoux (BE)

(21) Appl. No.: 14/442,861

(22) PCT Filed: Nov. 15, 2013
(86) PCT No.: PCT/EP2013/073991

§ 371 Date: May 14, 2015

(30) Foreign Application Priority Data
Nov. 15, 2012 (EP) 12192699.2

(51) Int. Cl. H01B 1/12

(52) U.S. Cl. CPC H01B 1/128

(57) ABSTRACT

Composition suitable for the manufacture of films comprising, in a solvent preparation a) at least one non-tubular graphene material b) at least one electrically conductive polymer which is selected from polythiophenes and derivatives and, c) at least one additive having a boiling point of at least 100° C. under atmospheric pressure, wherein the weight ratio of component a) to component b) is of at least 25:75 and up to 99.9:0.1.

The present invention relates to compositions suitable for the manufacture of films comprising, in a solvent composition, non-tubular graphene materials and conducting polymers.

Thin and flexible electrodes are becoming increasingly important in numerous applications like e.g. electronics and photonics.

Flexible electronic systems and applications require flexible electrodes with low cost production.

Indium-tin oxide (ITO) is the most commonly used material today for transparent electrodes in these applications. However, flexibility of such electrodes is not satisfactory and devices fabricated on flexible substrates break easily as a result of failure of the ITO as they are bent. Furthermore, it is generally expected that there will be a shortage of indium in the future which will make the use of ITO economically unfeasible.

To substitute ITO, significant research effort have been devoted to the development of electrically conductive polymers for flexible transparent and conducting films. One of the best investigated materials in this regard is poly(3,4-ethylenedioxythiophene/poly(styrenesulfonate), commonly referred to as PEDOT/PSS. However, some of the properties of conductive polymer based electronic devices are not fully satisfactory yet. One parameter which needs improvement is the charge mobility which limits the application potential. Another parameter where an improvement is desirable is the transparency in the blue colour region. The transparency of PEDOT/PSS films significantly decreases at wavelengths below 550 nm which deters the application of such products for transparent conducting films.

Single walled carbon nanotubes (SWCNT) and multi-walled carbon nanotubes (MWCNT) have also been investigated as replacement materials for ITO. SWCNT films provide good durability and flexibility combined with stable transparency over a broad wavelength spectrum. The charge mobility of devices using a SWCNT network is better than with conductive polymers. The long term stability of SWCNT films is not fully satisfactory, however.

To a certain extent composites of SWCNT and PEDOT/PSS show properties combining the advantages of both materials and thus respective combinations have been investigated. The conductivity of these materials still has some distance to the conductivity of ITO.

Wang et al., Diamonds & Related Materials, 22 (2012), 82-87 discloses the incorporation of single-walled carbon nanotubes with PEDOT/PSS in DMSO as a solvent for the production of transparent conducting films. SWCNTs are incorporated with PEDOT/PSS in DMSO for preparing flexible transparent conducting films on polyethylene terephthalate substrates. 1 mg of SWCNT was dispersed in 10 mL DMSO, the resulting dispersion was sonicated for two hours and thereafter centrifuged at 13000 rpm for 30 min. The supernatant was collected and subjected to centrifugation under the same conditions a second time. The final supernatant was mixed with a PEDOT/PSS solution in DMSO comprising 1.0 to 1.3 wt % of PEDOT/PSS in a volume ratio of 9:1. Accordingly, the weight ratio of SWCNT to DMSO was less than 1:10 (the concentration of the SWCNT in DMSO was less than 0.01 wt % after centrifugation), i.e. the PEDOT/PSS constituted the main component of the systems.

Park and Kim, Mat. Sci. Eng. B 176 (2011), 204-209 investigated the influence of dispersion of multi-walled carbon nanotubes on the electrochemical performance of PEDOT/PSS films. The MWCNT were treated with ethylene glycol to improve their dispersion in PEDOT/PSS. The treatment of the MWCNT with the ethylene glycol improved the mobility of the films by a factor of approximately 2. 2 ml of an aqueous PEDOT/PSS solution having a PEDOT/PSS content of appr. 0.7 wt % was mixed with a MWCNT solution in ethanol comprising at most 0.05 wt % of MWCNT in the volume ratio of 1:4.

Yin et al, J. of Nanoscience and Nanotechnology 10, 1934-1938 (2010), report the fabrication of high-efficiency polymer solar cells made with a hydrophilic graphene oxide doped in PEDOT/PSS composites and observed an improvement of the energy conversion efficiency by doping the graphene oxide into the PEDOT/PSS buffer layer of the cell. The PEDOT/PSS composite is not used as electrode material (this is ITO) but as a buffer layer to modify the ITO electrode and as hole collecting layer. The graphene oxide used is subjected to a chemical oxidation method referred to as modified Hummers method and thereafter it is necessary to remove ions of oxidant origin by applying at least 15 cycles of centrifugation, removal of the supernatant liquid and addition of new aqueous solution. Such process is not commercially feasible.

Chang et al., Adv. Funct. Mater. 2010, 20, 2893-2902 report the fabrication of transparent, flexible, low-temperature and solution-processible graphene composite electrodes. The graphene is obtained by surfactant assisted exfoliation of graphite oxide and subsequent in-situ chemical reduction. Spin-coating a mixture of a surfactant-functionalized graphene and PEDOT/PSS yields a graphene composite electrode showing good transparency and conductivity values and improved bending stability compared to ITO electrodes. The process for obtaining the modified graphene oxide is rather tedious and the graphene content in the mixture is less than 2 wt %. It is considered essential to modify the graphene by a treatment with sodium dodecyl benzene sulfonate (SDBS) leading to a modification of the graphene surface. The weight ratio of modified graphene to PEDOT/PSS is at most 1.6 wt %, i.e. the graphene content is very limited. Conductivity of a film with 1.6 wt % modified graphene is about three times higher than that of PEDOT/PS alone. This increase is attributed to the enhancement of the electrical network in the polymer matrix through the doping with graphene.

Whereas the aforementioned research efforts have led to a certain improvement in the desire to replace ITO by other suitable materials, there is still a need for suitable substituent materials showing the desired combination of properties, i.e. sufficient conductivity, transparency and flexibility.

Accordingly, it was an object of the present invention to provide compositions suitable for the manufacture of thin films, in particular films with a high transmission in the visible light range (i.e. in the range of from 400 to 800 nm).

This object is achieved with the compositions in accordance with claim 1.

The invention can also be viewed as a composition suitable for the manufacture of films comprising
at least one non-tubular graphene material [component a)]
at least one electrically conductive polymer which is selected from polythiophenes and derivatives [component b)]
at least one additive having a boiling point of at least 100° C. under atmospheric pressure [component c)], and
at least one solvent,
wherein the weight ratio of component a) to component b) is of at least 25:75 and up to 99.9:0.1. Usually, the weight ratio of component a) to component b) is of at least 25:75 and up to 99:1.

Preferred embodiments of the present invention are set forth in the dependent claims and the detailed specification hereinafter.

The compositions in accordance with the present invention may comprise at least one non-tubular graphene material and at least one electrically conductive polymer in a weight ratio which does not exceed 98:2, 97:3, 95:5, 90:10 or 80:20. In certain cases it has turned out to be advantageous if the weight ratio of graphene to conductive polymer does not exceed 95:5 or does not exceed 90:10.

The compositions in accordance with the present invention may comprise at least one non-tubular graphene material and at least one electrically conductive polymer in a weight ratio of at least 40:60, 50:50, 60:40, 70:30, 80:20, 90:10 or 95:5. In certain cases it has turned out to be advantageous if the compositions in accordance with the present invention comprise the two components in a weight ratio of at least 80:20 or at least 90:10.

The compositions in accordance with the instant invention contain (as component a)) a non-tubular graphene material, preferably a non-tubular graphene sheet material as hereinafter more precisely defined. Non-tubular as used herein shall mean that the graphene materials are not rolled-up in cylinders as e.g. in carbon nanotubes.

Non-tubular graphene materials compared to graphene nanotubes often show a more homogenous property spectrum in particular as conductivity is concerned. Synthesized carbon nanotubes are frequently mixtures of semiconductor carbon nanotubes and metallic carbon nanotubes and the two components are difficult to separate. The homogenous property spectrum, in particular with regard to conductivity, is an advantage of non-tubular products over carbon nanotubes.

Graphene itself is usually considered as a one-atom thick planar sheet of sp²-bonded carbon atoms that are densely packed in a honeycomb structure. The name graphene is derived from graphite and the suffix-ene. Graphite itself consists of a high number of graphene sheets stacked together.

Graphite, carbon nanotubes, fullerenes and graphene in the sense referred to above share the same basic structural arrangement of their constituent atoms. Each structure begins with six carbon atoms, tightly bound together chemically in the shape of a regular hexagon—an aromatic structure similar to what is generally referred to as benzene.

Perfect graphenes consist exclusively of hexagonal cells; pentagonal and heptagonal cells constitute defects in the structure. If an isolated pentagonal cell is present, the plane warps into a cone shape and the insertion of 12 pentagons would create a fullerene.

At the next level of organization is graphene itself, a large assembly of benzene rings in a basically planar sheet of hexagons that graphene materials to other substrates. resembles chicken wire. The other graphitic forms are built up out of graphene. Buckyballs and the many other nontubular fullerenes can be thought of as graphene sheets wrapped up into atomic-scale spheres, elongated spheroids and the like. Carbon nanotubes are essentially graphene sheets rolled into minute cylinders. And finally, graphite is a thick, three-dimensional stack of graphene sheets; the sheets are held together by weak, attractive intermolecular forces (van der Waals forces). The feeble coupling between graphite sheets enables graphite to be broken up into miniscule wafers.

In the chemical literature graphene was defined officially in 1994 by the IUPAC (Boehm et al., Pure and Appl. Chemistry 66, 1893-1901 (1994)), as follows:

A single carbon layer of the graphitic structure can be considered as the final member of the series naphthalene, anthracene, coronene, etc. and the term graphene should therefore be used to designate the individual carbon layers in graphite intercalation compounds.

According to the IUPAC compendium on technology, the term graphene should only be used when the reactions, structural relations or other properties of individual layers are discussed, but not for three-dimensional structures.

In the literature graphene has also been commonly referred to as monolayer graphite.

One way to obtain graphene is to exfoliate it, i.e. to peel it off from graphite with an adhesive tape repeatedly. Graphene produced this way is, however, extremely expensive and the product properties are difficult to control, i.e. the reproducibility of the process and the product properties are poor.

Another method is to heat silicon carbide to temperatures above 1100° C. to reduce it to graphene. This process produces a sample size that is dependent upon the size of the SiC substrate used. However, again products obtained by this process are again very expensive. Furthermore, since the outermost layer of the product is covalently linked to the substrate underneath, it is very difficult to transfer this graphene to other substrates.

Experimental methods have been reported for the production of graphene ribbons consisting of cutting open carbon nanotubes (Nature 2009, 367). Depending on the substrate used (single- or multi-walled nanotubes) single graphene sheets or layers of graphene sheets can be obtained. However, due to the fact that carbon nanotubes are very expensive materials, graphene products obtained this way are not commercially feasible.

M. Choucair et al., Nature Nanotechnology 4, 30-33 (2009) discloses a process for producing gram quantities of graphene by the reduction of ethanol by sodium metal, followed by pyrolysis of the ethoxide product and washing with water to remove sodium salts.

Recently, a new type of graphene materials, so called nano-graphene platelets or NGP (sometimes also referred to as nanographite platelets or graphite nanoplatelets, graphene nanoplatelets (GNP), reduced graphene oxide (rGO) or graphite platelets), has been developed and respective products are commercially available, for example from Angstron Materials LLC or XG Sciences. NGP refers to an isolated single layer graphene sheet (single layer NGP) or to a stack of graphene sheets (multi-layer NGP). NGPs can be readily mass produced and are available at lower costs and in larger quantities compared to single walled (SW), double walled (DW) or multi-walled (MW) carbon nanotubes. A broad array of NGPs with tailored sizes and properties can be produced by a combination of thermal, chemical and mechanical treatments.

Typically, without being limited thereto, the stack thickness of NGPs can be as low as 0.34 nm (single-layer NGP) and up to 100 nm or even more (multi-layered NGP). The number of single layers in a NGP can be easily derived from the stack thickness by dividing same by the thickness of a single graphene layer (which is 0.34 nm). Thus, e.g. a NGP with a stack thickness of 2 nm comprises 6 single graphene layers.

The aspect ratio of NGPs can generally cover a very broad range of from 1 to 60,000, preferably of from 1 to 25,000 and most preferably of from 1.5 to 5000. Particularly preferred platelets have an aspect ratio in two directions or dimensions of at least 2, in particular of at least 3 or more. This aspect ratio applies for nanographene platelets in two dimensions and in this aspect nanographene platelets differ fundamentally from carbon black or carbon-nanotubes. Carbon black particles are spheroidal and lack any significant aspect ratio relating to their dimensions. Carbon-nanotubes have a high aspect ratio in one direction, along the length or main axis of the carbon tube. This is a characteristic feature of an elongated structure like a fibrous or needle like particle. Compared to this, platelets have a high aspect ratio for two of the three directions or dimensions relative to the third direction or dimension. This difference has a significant influence on the properties of the products in accordance with the instant invention as is apparent from the examples. Typically, the length and width of NGPs parallel to the graphene plane is in the range of from 0.5 to 20 micrometers.

The specific surface area of NGP can vary over a wide range, but is generally higher than the specific surface area of standard graphite when measured under identical conditions. This is an indication of the inherently much finer scale and exfoliation of NGPs. Although there are other forms of carbon also having increased specific surface areas such as carbon-nanotubes, same surprisingly do not offer the combination of benefits and advantages seen for NGP. The specific surface area, as measured by the BET method (as described in detail in the examples) in many cases exceeds 10 m²/g, preferably exceeds 20 m²/g and even more preferably exceeds 50 m²/g and may be as high as exceeding 70 m²/g, preferably exceeding 100 m²/g and even exceeding 200 m²/g. In certain cases surface areas of more than 300 m²/g have proven to provide very good results and thus non-tubular graphene materials having a surface area as measured by the BET method of more than 300 m²/g, very particularly exceeding 500 m²/g are particularly preferred.

Furthermore, NGPs are available in different degrees of polarity, characterized by the oxygen content of the graphene surface. NGPs having a high oxygen content exceeding 0.5% by weight are generally referred to as polar grades whereas NGPs having an oxygen content of less than 0.5% by weight, preferably 0.2% by weight or less are referred to as non-polar grades. Non polar grades have generally proven to be advantageous, in particular grades having very low oxygen contents, in many cases not exceeding 0.1 wt %. All these types of products are commercially available, for example from Angstron Materials LLC and XG Sciences, other suppliers offering part of the range.

All structural parameters discussed hereinbefore and hereinafter refer to the graphene materials as such, i.e. these properties are determined prior to the incorporation of the graphene material into the composition in accordance with the present invention.

Graphene materials as referred to herein encompass all the different products defined above, which are principally suitable for the purpose of the instant invention. Nano-graphene platelets (NGPs) have proven particularly advantageous in a number of cases and for a significant number of applications.

Whereas the stack thickness of the NGPs is not particularly critical, it has been observed that products having a stack thickness significantly exceeding 10 nm form larger agglomerates of up to 50 micrometers which is an indication of a deterioration of the NGP dispersion or distribution in the matrix, whereas products having stack thicknesses of 10 nm or less show a more uniform distribution of the NGP in the matrix, which is advantageous when aiming for the improvement of certain properties.

The polarity, i.e. the oxygen content of the NGP can have an influence on specific properties of the compositions in accordance with the instant invention.

Preferred NGPs for use in the compositions in accordance with the instant invention can be obtained in accordance with the methods in U.S. Pat. No. 7,071,258 and US patent application 2008/0279756, referred to hereinbefore.

The NGPs in accordance with U.S. Pat. No. 7,071,258 comprise at least a nanometer-scaled plate with said plate comprising a single sheet of graphene plane or a multiplicity of sheets of graphene plane; said graphene plane comprising a two-dimensional lattice of carbon atoms and said plate having a length and a width parallel to said graphene plane and a thickness orthogonal to said graphene plane characterized in that the length, width and thickness values are all smaller than approximately 100 nm, preferably smaller than 20 nm.

The process in accordance with US patent application 2008/0279756 yields NGP's with stack thicknesses of generally 100 nm or smaller, preferably 10 nm or smaller. As mentioned earlier, a single sheet NGP has a stack thickness of 0.34 nm. The particle length and width of additive products in accordance with this prior art reference typically range of from 1 to 50 micrometers, preferably of from 1 to 25 micrometers but can be longer or shorter.

Component b) of the compositions in accordance with the present invention is an electrically conductive polymer which is selected from polythiophenes and derivatives.

Generally electrically conductive polymers comprise two structural features which influence their performance in organic electronic and photonic devices.

The first is a π-conjugated backbone comprised of linked unsaturated units resulting in extended π-orbitals along the polymer chain. Thereby proper charge transport is achieved.

The second structural feature often found in electrically conductive polymers is the functionalization of the polymer core with solubilizing substituents. Increasing the solubility is advantageous as it enables the use of solution based processes for manufacture of the films which is generally preferred over vapour deposition methods or the like.

Unsaturated units which are commonly found in electrically conductive polymers are mono- or polycyclic aromatic hydrocarbons, heterocycles, benzofused systems and simple olefinic and acetylenic groups. The extent of interaction between the units determines the electronic structure of the polymer as well as its electronic properties. Other factors which influence the properties of the electrically conductive polymers are molecular weight and the polydispersity index as these parameters influence solubility and formulation rheology.

Very schematically, electrically conductive polymers comprising the two structural features described above may be represented as follows

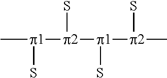

wherein π1 and π2 may be the same or different and represent the π-conjugated backbone and S, which may be present in all or part of the units π1 and π2, represents solubilizing substituents.

The electrically conductive polymer in accordance with the present invention can be a homopolymer or a copolymer including a block copolymer or a random copolymer, or a terpolymer provided that it is selected from polythiophenes and derivatives. The electrically conductive polymer can comprise a conjugated polymer soluble or dispersible in organic solvent or water. The electrically conductive polymer can comprise one or more members of a family of similar polymers (i.e. a mixture of polymers) which have a common polymer backbone but are different in the derivatized side groups to tailor the properties of the polymer. For example, polythiophenes can be derivatized with alkyl side groups including methyl, ethyl, hexyl, dodecyl, and the like.

According to one embodiment copolymers and block copolymers which comprise, for example, a combination of conjugated and non-conjugated polymer segments, or a combination of a first type of conjugated segment and a second type of conjugated segment, may be used. For example these can be represented by AB or ABA or BAB systems wherein, for example, one block such as A is a conjugated block and another block such as B is an non-conjugated block or an insulating block. Or alternatively, each block A and B can be conjugated. The non-conjugated or insulating block can be for example an organic polymer block, an inorganic polymer block, or a hybrid organic-inorganic polymer block including for example addition polymer block or condensation polymer bloc.

The structure of the polymer itself is not particularly critical provided the polymer is selected from polythiophenes and derivatives and has the required charge mobility and can be made into films with the desired good transmission in the range of from 400 to 800 nm.

Accordingly, a skilled person can select the appropriate conductive polymer based on experience from a number of products commercially available or may synthesize the suitable polymer in accordance with methods described in the literature.

Thus, the at least one electrically conductive polymer of the invented compositions is selected from polythiophenes and derivatives. Polythiophenes and derivatives represent a particularly attractive group of electrically conductive polymers. They can be homopolymers or copolymers, including block copolymers and they can be soluble or dispersible. The polymers can be regioregular. A polymer is deemed to be regioregular if all the repeat units are derived from the same isomer of the monomer from which the polymer is produced (obviously regioregularity can only be described if there is more than one isomer of the monomer from which the polymer is formed). The degree of regioregularity thus describes the percentage of repeating units in the polymer chain derived from the same isomer of the monomer. Regioregular polythiophenes are as described in for example U.S. Pat. Nos. 6,602,974 and 6,166,172 to McCullough et al., as well as McCullough, R. D., Tristram-Nagle, S., Williams, S. P.; Lowe, R. D., Jayaraman, M. J. Am. Chern. Soc. (1993), 115, 4910, including homopolymers and block copolymers.

In particular, optionally substituted alkoxy- and optionally substituted alkyl-substituted polythiophenes can be used. Soluble alkyl- and alkoxy-substituted polymers and copolymers can be used including poly(3-hexylthiophene, P3HT). Other examples can be found in U.S. Pat. Nos. 5,294,372 and 5,401,537.

Additional examples of p-type materials and polythiophenes can be found in WO 2007/011739 (Gaudiana et al.) which describes polymers having monomers which are, for example, substituted cyclopentadithiophene moieties.

A first particularly preferred electrically conductive polymer derived from a polythiophene is a polymer mixture of two ionomers known as Poly(3,4-ethylenedioxy)thiophene) polystyrene sulfonate (frequently referred to as PEDOT/PSS) which comprises the following structural units

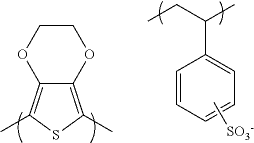

Part of the sulfonyl groups of the sulfonated polystyrene (PSS) unit are deprotonated and thus carry a negative charge. The PEDOT, the other component is a conjugated polymer and carries positive charges.

PEDOT/PSS films show a good transparency in the region of from 600 to 800 nm and a high ductility which is important in the manufacture of flexible organic electronic devices.

PEDOT/PSS is available as commercial product from a number of suppliers.

Another electrically conductive polymer which finds frequent use in organic photovoltaic devices is poly(3-hexyl)thiophene, also known as P3HT

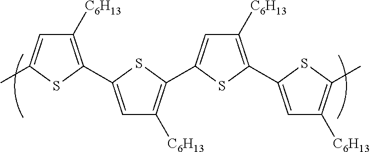

Structural variations of this polymer as well as other polymers and copolymers comprising thiophene units have been described in the literature as conductive polymers for organic electronic devices (for an overview see the review of Facchetti et al. referred to above).

The following examples are shown as representatives for such polymers

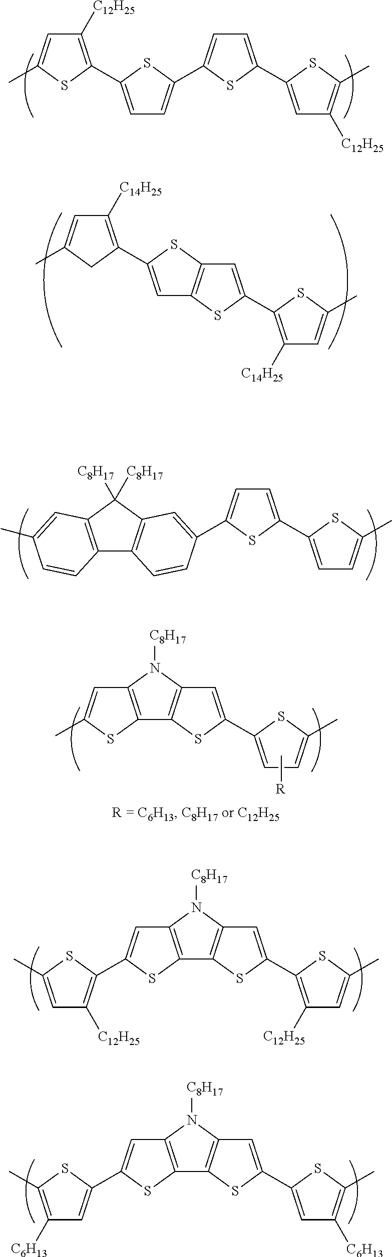

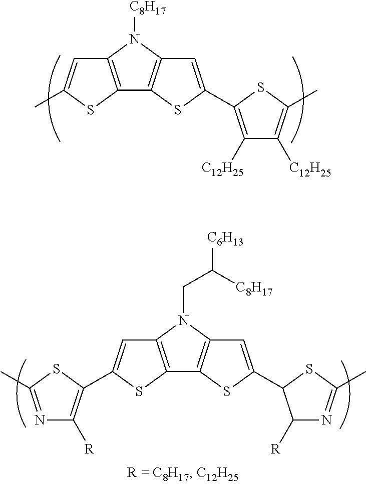

Polymers comprising fused thiophene units have also been described and some examples thereof are reproduced below

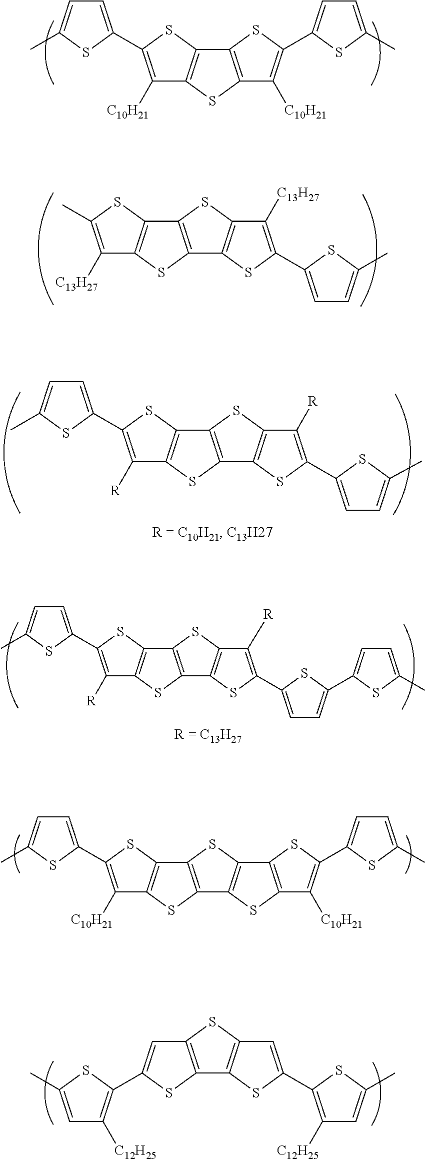

In the invented compositions, polythiophenes (namely polymers comprising thiophene units) and derivatives (such as PEDOT/PSS), described in more detail above, provided a good combination of conductivity, transparency and stability, which generally cannot be achieved in with other electrically conductive polymers.

The compositions in accordance with the present invention are provided in a solvent preparation. The solvent preparation may comprise one or more than one solvent; in case of mixtures of solvents it is preferred that the solvents in the solvent preparation have a certain miscibility with each other to facilitate the manufacture of thin homogenous films.

The solvents in the solvent preparation are typically selected based on the type of electrically conductive polymer and should provide a sufficient solubility of the electrically conductive polymer. The non-tubular graphene material (component a) of the compositions in accordance with the present invention may be provided in the same solvent as the electrically conductive polymer, in which case the solvent preparation comprises usually one solvent only. If the non-tubular graphene material and the electrically conductive polymer are provided in different solvents, the solvent preparation generally comprises at least two solvents and in some cases it may be advantageous to add a third solvent capable of improving the compatibility of the two solvents in which component a) and component b) are provided, if necessary.

The concentration of the electrically conductive polymer b) in the solvent preparation in many cases is in the range of from 0.01 to 5 wt %, preferably of from 0.05 to 3 wt %, based on the weight of the solvent for the conductive polymer. The concentration of graphene materials in the solvent for the non-tubular graphene material usually will be in the range of from 0.0001 wt % to 5 wt %, preferably of from 0.0005 to 2 wt %, based on the weight of the solvent for the non-tubular graphene material. Preferably the concentration is in the range of from 0.001 g/L to 5 g/L.

In accordance with a preferred embodiment, the solvent preparation comprises water, N-Methyl pyrrolidone (NMP) or dimethylsulfoxide (DMSO) or mixtures thereof, preferably the solvent preparation comprises water. Other solvents are also suitable, provided the non-tubular graphene material and/or the electrically conductive polymer are soluble therein to an extent that homogenous continuous films may be obtained from the respective compositions.

If mixtures of different solvents are present in the solvent preparation it is usually a mixture of solvents one of which provides sufficient solubility for the non-tubular graphene material and the other one provides sufficient solubility for the electrically conductive polymer. Additional solvents may be present to enhance compatibility between the solvent for the graphene material and the solvent for the electrically conductive polymer. The additional solvent in those cases usually acts as a compatibilizer between the solvents for the components.

In some cases it has also been found advantageous to use solvents with different boiling point ranges as this has advantages in certain solution based processing methods. A combination of solvents with different boiling points can be helpful in fine-tuning the evaporation properties of the solvent preparation. A solvent with a low boiling point is advantageous for the quick drying after deposition of the compositions of the present invention on a substrate to obtain a film through evaporation of the solvent. However, if the solvent evaporates too quickly, the homogeneity and quality of the films may be negatively affected. Thus, combinations of solvents with different boiling point ranges can be advantageous.

Preferably mixtures of solvents with different boiling points in the solvent preparation comprise at least one solvent with a boiling point under atmospheric pressure of 125° C. or less and another solvent with a boiling point under atmospheric pressure exceeding 125° C.

Exemplary solvents of this first group are toluene, pyridine, thiophene, thiazole, esters of alkanoic acids, in particular esters of C₁-C₅ alkanoic acids with C₁-C₄ alcohols, comprising a total number of carbon atoms of at most 6, e.g. ethyl acetate, propyl acetate, butyl acetate, ethyl propionate, propyl propionate, methyl butyrate, ethyl butyrate or methyl pentanoate or dialkyl ethers like e.g. dipropyl ether, ethyl propyl ether, ethyl-tert. butyl ether and methyl-tert. butyl ether. Also suitable are carbocyclic solvents like e.g. cyclohexane or cycloheptane, which may be substituted or unsubstituted like e.g. methylcyclohexane or the like, dialkylketones with lower alkyl groups like e.g. methyl isobutyl ketone or linear alkanes like e.g. n-hexane, n-heptane or n-octane and the branched isomers thereof. Preferred solvents within the group of first solvents are those which have a boiling point of at least 80° C. as lower boiling solvents might evaporate too fast after the application of the composition which could detrimentally influence the properties of the desired films.

Preferred solvents of the second group (boiling point exceeding 125° C. under atmospheric pressure) are selected from the group consisting of isomeric xylenes, the isomeric trimethyl benzenes, ethyl benzene, the isomeric propyl benzenes and the isomeric butyl benzenes. Furthermore, the C₁ to C₆ esters of C₃ to C₈ alkanoic acids having a total number of carbon atoms of at least 7 like e.g. n-butyl propionate, propyl butyrate, butyl butyrate, isobutyl isobutyrate, ethyl pentanoate and propyl pentanoate, dialkylketones like methyl isoamylketone, methyl amyl ketone or ethyl amyl ketone and higher dialkyl ethers like e.g. dibutyl ether or propyl butyl ether may be mentioned. In accordance with a preferred embodiment, the solvents of this group, however, do not contain alkoxy or aryloxy groups and even more preferably the solvents of this group do not contain oxygen in their molecular structure at all. In certain cases the isomeric xylenes and in particular m-xylene have shown to provide beneficial properties to the final products. It is also possible to use solvents having boiling points exceeding 200° C. under atmospheric pressure, like e.g. the isomeric alkylated benzenes with alkyl groups comprising at least 5 carbon atoms, condensed ring systems comprising at least one aryl group and a cycloalkyl group annealed with the aryl group like e.g. tetralin, and unsubstituted cycloalkanes having at least 8 carbon atoms like cyclooctane and cyclononane, or substituted cycloalkanes with at least six carbon atoms in the ring and bearing alkyl substituents having at least six carbon atoms like e.g. hexylcyclohexane as well as alkylated aniline derivatives may be mentioned. Furthermore, aldehydes like salicylaldehyde or anisaldehyde may be mentioned. From the foregoing those solvents free of alkoxy or aryloxy groups and in particular those solvents free of oxygen in their molecular structure are particularly preferred.

If the solvent preparation comprises more than one solvent, the mixture ratio (ratio by weight) of the different solvents is not very critical and can be chosen over a wide range of from 5:95 to 95:5, preferably of from 20:80 to 80:20. In certain cases it has proved to be advantageous to keep the content of high boiling solvents below 25 wt %, especially below 20 wt %, based on the weight of the solvent preparation.

The solvent with the highest percentage in the solvent system preferably has a melting point at atmospheric pressure below 50° C. and more preferably below room temperature (23° C.), i.e. it should particularly preferably be liquid at room temperature.

Even more preferably, all solvents in the solvent system have a melting point under atmospheric pressure of below 50° C., most preferably below 23° C.

In accordance with another preferred embodiment the compositions in accordance with the present invention may comprise further additives like surfactants or additives enhancing the conductivity of the compositions in accordance with the present invention.

The performance of devices based on polymeric conductive materials has been found to be related to the morphological properties of the active materials.

In accordance with the present invention, the conductivity of electrically conductive polymersis enhanced by the addition of minor amounts of at least one high boiling point additive. A high boiling point additive for the purpose of the present invention is an additive, the boiling point of which exceeds 100° C., preferably 120° C. under atmospheric pressure. The high boiling point additive may be selected e.g. from the solvents with boiling points under atmospheric pressure exceeding 125° C. described above as potential components of the solvent preparation. In this case the additive may function as solubility and as conductivity enhancer at the same time.

While the mechanism of the conductivity improvement is not yet fully known, it is believed that the high boiling point additive has an influence on interchain reactions and induce conformational changes in the polymers.

The high boiling additive is advantageously selected from the group consisting of dialkyl sulfoxides, N-alkyl pyrrolidones, polyalkylene glycols, N,N-dialkyl-formamides, N,N-dialkyl-alkylamides and alcohols having more than two OH-groups.

Dialkyl sulfoxides include two alkyl groups. These ones can be linear, ramified or cyclic (e.g. cyclohexyl). Both alkyl groups are preferably linear. Besides, both alkyl groups of the dialkyl sulfoxides contain preferably from 1 to 6 carbon atoms, more preferably from 1 to 3 carbon atoms; still more preferably, they are methyl groups.

The akyl group of N-alkyl pyrrolidones can be linear, ramified or cyclic (e.g. cyclohexyl). It is preferably linear. Besides, it contains preferably from 1 to 6 carbon atoms, more preferably from 1 to 3 carbon atoms; still more preferably, the N-alkyl pyrrolidone is N-methylpyrrolidone.

Polyalkylene glycols can be chosen from polypropylene glycols and polyethylene glycols. Polyalkylene glycols contain preferably at most 8, more preferably at most 4, still more preferably at most two alkylene oxide (e.g. ethylene or propylene oxide) moeieties. Diethylene glycol is particularly suitable.

N,N-dialkyl-formamides include two alkyl groups. These ones can be linear, ramified or cyclic (e.g. cyclohexyl). Both alkyl groups are preferably linear. Besides, both alkyl groups of the dialkyl sulfoxides contain preferably from 1 to 6 carbon atoms, more preferably from 1 to 3 carbon atoms; still more preferably, they are methyl groups.

N,N-dialkyl-alkylamides can be chosen from N,N-dialkyl-acetamides,

N,N-dialkyl-propionamides and N,N-dialkyl-butanamides. Both alkyl groups (which hereinafter marked *) of the N,N-dialkyl*-acetamides, N,N-dialkyl*-propionamides, N,N-dialkyl*-butanamides and higher N,N-dialkyl*-alkylamides can be linear, ramified or cyclic (e.g. cyclohexyl). Both alkyl* groups are preferably linear. Besides, both alkyl* groups contain preferably from 1 to 6 carbon atoms, more preferably from 1 to 3 carbon atoms; still more preferably, they are methyl groups.

The alcohols having more than two OH-groups per molecule have preferably more than 3, still more preferably more than 4 OH-groups per molecule. On the other hand, they have preferably at most 20, more preferably at most 12, still more preferably at most 8 OH-groups per molecule. Sorbitol is particularly suitable.

Particularly good effects with high boiling point additives have been observed with polymers comprising thiophene units and in particular with PEDOT/PSS described in more detail hereinbefore.

Especially DMSO, sorbitol, N-methyl pyrrolidone (NMP), diethylene glycol and dimethylformamide (DMF) have proven to be advantageous high boiling point additives.

The amount of the high boiling point additive, based on the total weight of the invented composition, ranges generally from 0.001 to 30 wt %. It can be of at least 0.002 wt %, at least 0.005 wt. %, at least 0.01 wt %, at least 0.02 wt %, at least 0.05 wt %, at least 0.1 wt. % or at least 0.2 wt %, based on the weight of the composition. It can be of at most 10 wt %, at most 3 wt %, at most 1 wt. %, at most 0.5 wt %, at most 0.2 wt %, at most 0.1 wt or at most 0.05 wt %, based on the weight of the composition. All possible combinations of the previously cited lower and upper limits (such as from 0.01 wt % to 0.5 wt %) are suitable ranges in accordance with the present invention, and must be considered as herein explicitly listed. In particular, if the high boiling point additive is not part of the solvent preparation as ingredient of the solvent mixture, it is usually added in an amount of from 0.01 to 20 wt %, preferably of from 0.1 to 10 wt % and especially preferably in an amount of 0.5 to 8 wt %, in each case based on the weight of the solution of the electrically conductive polymer.

The high boiling point additive may be added to the solvent preparation comprising the non-tubular graphene material and the electrically conductive polymer or it may be added to the solution of the electrically conductive polymer before mixing same with the solution comprising the non-tubular graphene material. In some cases it has proved to be advantageous if the high boiling point additive is added to the solvent comprising the electrically conductive polymer before mixing with the solvent comprising the non-tubular graphene material.

The compositions in accordance with the present invention may be obtained by preparing separate solutions of the non-tubular graphene material and the electrically conductive polymer and mixing same, optionally together with a high boiling point additive as described above to obtain the composition in accordance with the present invention. Alternatively, a solution of either the non-tubular graphene material or the electrically conductive polymer may be prepared and thereafter the second component (either the non-tubular graphene material or the electrically conductive polymer) may be added in the desired amount.

In some cases it has been shown to be particularly advantageous to subject the dispersion of the non-tubular graphene material to a treatment to improve homogeneity of the dispersion of the non-tubular graphene material. Milling methods, including ball milling, jet milling or centrifugal milling may be mentioned as well as stirring methods like magnetic stirring or overhead stirring. High speed homogenisers and high pressure homogenisers may also be mentioned. In high speed homogenizers a rotor acts as a centrifugal pump to recirculate the liquid and to suspend the solids through the generator where same will be subjected to shear, impact collisions and cavitations. High pressure homogenisers use shear and cavitation effects provided via an increase in the velocity of a pressurised liquid stream in microchannels. Finally, sonication methgods like ultrasonic bath or ultrasound probe sonication or ultrasound disruption methods may be mentioned.

Preferred treatment include sonication or ball milling, with sonication being particularly preferred. Sonication treatment times of from 5 min to 3 hrs, in particular of from 30 min to 120 min are usually sufficient to obtain the desired effect.

The compositions of the present invention can advantageously be used in the manufacture of films which may be used as electrodes in organic, inorganic or hybrid electronic devices.

The compositions of the present invention can be used in any known process for the manufacture of thin films, i.e. there are no limitations or restrictions in this regard.

In certain cases it has proved to be advantageous to use processing techniques avoiding very high shear rates e.g. exceeding 50000 s⁻¹ as are conventionally encountered in inkjet printing. Accordingly, slot die coating, spray-coating, knife coating or blade coating may be mentioned here as preferred techniques for processing the compositions of the present invention, amongst which slot die coating and spray-coating has shown to be advantageous in a number of cases. These methods normally do not involve shear rates as high as in inkjet-printing.

A slot coating die is a device which is capable of holding the fluid's temperature, distributing a fluid uniformly and exactly defining a coating width. In slot die coating normally a displacement pump is used to deliver a constant supply of coating fluid to the slot die. This allows good control of the coatweight by regulating the pumping rate. Furthermore cross-web distribution control is also possible. Finally, a slot die system is a closed system which reduces coating fluid contamination, which is especially useful in a clean room environment.

Suitable devices for slot die coating processes are known to the skilled person and described in the prior art so that no detailed description is necessary here.

Spray coating methods represent another suitable and preferred method to produce films (“sheet like materials”) in accordance with the present invention. Spray coating is usually carried out in ambient atmosphere at temperatures or preferably at most 250° C., more preferably of at most 200° C. and even more preferably of at most 150° C.

The conductivities of the films obtained from compositions in accordance with the present invention depends on film thickness but conductivities comparable to those obtained with ITO can be obtained. Thus, film resistances of less than 300, preferably less than 200 and in some cases less than 100 Ω/square may be obtained. The film resistance or conductivity of the films is usually determined through the 4 square pin method (also known as Van der Pauw method).

The compositions of the present invention are useful for the preparation of films which can be deposited on rigid or flexible substrates and be used as transparent electrodes in a variety of applications where a combination of transparency (in the visible region) and good conductivity is required. The thickness of these films is preferably in the range of from 0.34 to 500 nm, preferably of from 1 to 250 nm and particularly preferably of from 5 to 200 nm. Film resistance usually decreases with increasing film thickness; at the same time, however, transparency of the films obtained from the compositions in accordance with the present invention deteriorates with increasing film thickness. For certain applications transparencies (measured at 550 nm) should not be less than 50, preferably not be less than 60% and particularly preferably not less than 70%, most preferably not less than 80%, while the film resistance should be at most 500 Ω/sq, preferably at most 150 Ω/sq most preferably less than 100 Ω/sq, measured in accordance with the Van de Pauw method.

The compositions in accordance with the present invention can thus be used as materials for the manufacture of films for transparent electrodes for electrochromic windows, de-icing windows, E-glass, EMI shielding devices, antistatic devices, various types of displays like LCD, OLED, electroluminiscent displays, electrophoretic displays, electrochromic displays, OLED lighting applications and organic photovoltaic cells. Thus, the compositions of the present invention have a very broad range of industrial applicability.

Another object of the present invention are transmissive electrodes, having an optical transmission at 550 nm at a thickness of 100 nm of at least 50% and organic electronic devices comprising a film obtained from a composition in accordance with the present invention.

The following examples show the advantages of the compositions in accordance with the present invention without, however, limiting the scope of the invention to those working examples. The skilled person will know how to vary the parameters shown in the working examples to adjust the composition in an optimal manner to a specific application situation.

### EXAMPLES

### Sonication Treatment

The equipment used was a 400 Watts sonifier (Branson Digital S-450D) equipped with a 13 mm sonotrode. To avoid excessive elevation of the temperature during sonication, the beaker containing the mixture to be treated (the non-tubular graphene material in a solvent) was immersed in an oil bath at a temperature of −15° C. and the maximum temperature was set at 82° C. The conditions were 50 sec as the treatment duration at 100% amplitude, followed by a 60 second interval. Overall treatment time was 30 to 120 min.

### Thin Film Manufacture

The solution obtained after sonication was deposited on a 3×3 cm² commercial soda-lime glass substrate. The substrates were cleaned prior to deposition of the films through sonication for 30 minutes in a detergent RBS® solution (obtained from Thermo Scientific) and in de-ionized water. Thereafter the substrates were heated at 80° C. in isopropanol to remove residual traces of impurities and finally treated 10 min in ozone to improve surface wettability using a UV-ozone cleaner from Ultra Violet Cleaning Systems which generated UV radiation in the 185 and 254 nm range.

Thin films were deposited from solutions comprising non-tubular graphene material and electrically conductive polymer by spin coating on the glass substrates cleaned as described at room temperature i.e. 23° C. (Examples 1 to 8), or by spray coating at a substrate temperature of 150° C. (Examples 9 and 10).

The concentration of the dispersions used for spin coating was 1.1 mg/ml of carbon material in water as solvent (either non-tubular graphene in accordance with the present invention or other carbon material). Rotation speed was 2000 min⁻¹ at an acceleration of 1500 rpm/s and the duration of spin coating was 40 seconds. The obtained films were heated at 100° C. and under vacuum in order to remove residual solvents.

Spray coating (Examples 9 and 10) of the sonicated solutions onto a glass substrate cleaned as described above was carried out using a spray coating equipment available from Airbrush Evolution Harder & Steenbeck at an applied pressure of two bars (202.650 KPa) using a nozzle with a diameter of 0.20 mm and a distance between substrate and nozzle of 12 cm. The substrate was placed on a heater plate kept at 150° C. before spraying and the deposition was achieved by multi-step spraying with appr. 62 μl/step with a total deposition volume of appr. 750 μl. Prior to spray coating the sonicated dispersion was subjected to a centrifugation at 1000 rpm for 30 min in Example 9 and at 2000 rpm for 30 minutes in Example 10. The concentration of carbon material in the starting dispersion in example 9 was 0.5 mg/ml and 1.1 mg/ml in Example 10.

The films prepared by spin coating had typically an average layer thickness of from about 75 nm to about 150 nm, with a targeted value of about 100 nm; film 6 was however somewhat thicker, while film 8 was somewhat thinner, with average values of about 190 nm and 30 nm respectively. On the other hand, both films prepared by spin coating had an average layer thickness of about 200 nm.

### Optical Transparency

Optical transmittance of the films was determined using a Perkin Elmer Lambda UV-VIS spectrometer at a wavelength of 550 nm at the given layer thickness.

### Sheet Resistance

Sheet resistance was measured in accordance with the Van der Pauw method as described in “Electrical characterization of carbon-polymer composites: Measurement techniques and related problems; Grivei E, Probst N., Rubber Chem. Conference 1999, Antwerp, Belgium, pp. 5.1 to 5.6.

### Figure of Merit (FOM)

As the skilled person is well familiar with, in order to compare the performances of transparent and conductive films of different natures and thicknesses, one advantageously uses the ratio between the direct current (DC) conductivity and the optical conductivity. This ratio is commonly referred to as “figure of merit” (FOM). The higher FOM is, the better. This figure of merit (FOM) is easily calculated from the sheet resistance and transmittance values of the film using the following equation: σ_{DC}/σ_{OP} (550 nm)=188.5/Rₛₕₑₑₜ (T^{-1/2}31 1) wherein Rₛₕₑₑₜ is the sheet resistance (expressed in Ω/sq) and T is the transmittance at 550 nm.

To study the effect of addition of a high boiling additive, DMSO was added in certain experiments in an amount of 5 wt %, based on the amount of PEDOT/PSS solution.

The electrically conductive polymer used was a commercial aqueous PEDOT/PSS polymer solution available from HC Starck under the tradename Clevios® PH 1000 with a concentration of conductive polymer in the range of from 1.0 to 1.3 wt %.

The weight ratio of carbon material to PEDOT/PSS was 90:10 in Examples 1 to 8 and 50:50 in Examples 9 and 10.

Table 1 shows the results of the experiments made.

| | | Soni- | | Sheet | Transmit- | σ_{DC}/σ_{OP} |
|---|---|---|---|---|---|---|
| Ex. | Carbon | cation | | res. | tance at | (550 nm) |
| No. | material | (min) | DMSO | Ω/sq | 550 nm (%) | (FOM) |
| 1C | none | none | no | 95000 | 95 | 0.1 |
| 2C | none | none | yes | 4600 | 95 | 1.6 |
| 3C | SWCNT | 60 | no | 213000 | 93 | 0.02 |
| 4C | SWCNT | 60 | yes | 265 | 72 | 4 |
| 5 | EG1 | 60 | yes | 285 | 90 | 12.2 |
| 6C | EG1 | 120 | no | 92000 | 75 | 0.01 |
| 7 | EG1 | 120 | yes | 80 | 74 | 14.5 |
| 8 | XGS GNP | 120 | yes | 296 | 90 | 11.8 |
| 9 | EG1 | 60 | yes | 323 | 70 | 3 |
| 10 | EG2 | 60 | yes | 89 | 76 | 14.5 |

SWCNT was single walled carbon nanotubes obtained from Skyspring Nano (product reference #0550CA), EG1 was a non-tubular graphene material in the form of expanded graphite obtained from Timcal, XGS GNP was graphene nanoplatelets obtained from XG sciences (xGnP-M-15).

EG2 was a non-tubular graphene material in the form of expanded graphite obtained by a thermal shock at high temperature in a pre-heated oven and under nitrogen of an expandable graphite obtained from Asbury (grade 3772—expansion ratio 300:1). The principle of thermal expansion relies in the fact that the compounds trapped between the graphite layers decompose and force the graphite layers to separate randomly. The expansion process results in the disappearance of the initial compacted tiled structure of the graphite, resulting in an enormous increase in volume. In this example, the flash thermal conditions used were a temperature of 800° C. and a reaction time of 2 minutes.

The results of the experiments, in particular the FOM results, show that non-tubular graphene materials have a superior performance over carbon nanotubes. In particular, the FOM of the graphene-based film of example 5 (according to the invention) was about three times higher than the FOM of the CNT-based film of comparative example 4C, while both films were obtained by spin coating from DMSO-contg. solutions having received the same sonication.

Furthermore, the data show that sonication as well as addition of DMSO as high boiling point additive to the solution of the electrically conductive polymer significantly improved the properties of the films obtained from the composition in accordance with the present invention. PEDOT/PSS alone, even with addition of DMSO did not provide sheet resistances in the range necessary. Thus, the non-tubular graphene material in combination with the electrically conductive polymer and the high boiling point additive provided unexpected and beneficial properties which are highly valuable when using the compositions for the manufacture of thin films suitable as transparent electrodes for a variety of applications.

1. A composition suitable for the manufacture of films, the composition comprising, in a solvent preparation
a) at least one non-tubular graphene material,
b) at least one electrically conductive polymer which is selected from polythiophenes and derivatives and,
c) at least one additive having a boiling point of at least 100° C. under atmospheric pressure,
wherein the weight ratio of component a) to component b) is at least 25:75 and up to 99.9:0.1.

2. The composition in accordance with claim 1, wherein the weight ratio of component a) to component b) is up to 99:1 and at least 80:20.

3. (canceled)

4. The composition in accordance with claim 1 wherein the non-tubular graphene material is selected from the group consisting of nanographene platelets, expanded graphite and reduced graphene oxide.

5. The composition in accordance with claim 1 wherein the electrically conductive polymer is PEDOT/PSS.

6. (canceled)

7. (canceled)

8. The composition in accordance with claim 1 wherein the solvent preparation comprises water.

9. (canceled)

10. The composition in accordance with claim 1 wherein the solvent preparation comprises DMSO.

11. (canceled)

12. The composition in accordance with claim 1 wherein components a) and b) are dispersed in the solvent preparation and the concentration of the electrically conductive polymer b) in the solvent preparation is of from 0.001 g/L to 5 g/L.

13. A method for the manufacture of a film, the method comprising using the composition in accordance with claim 1.

14. A film obtained from the composition in accordance with claim 1 the film having a thickness of from 0.34 to 500 nm.

15. A transmissive electrode for an organic electronic device with a transmission at 550 nm and a film thickness of 100 nm of at least 50%, comprising the film in accordance with claim 14.

16. An electronic device comprising the film in accordance with claim 14 as part of at least one of the electrodes.

17. A composition suitable for the manufacture of films, the composition comprising, in a solvent preparation
a) at least one non-tubular graphene material which is selected from the group consisting of nanographene platelets, expanded graphite and reduced graphene oxide,
b) at least one electrically conductive polymer which is selected from polythiophenes and derivatives and,
c) at least one additive having a boiling point of at least 100° C. under atmospheric pressure which is selected from dialkyl sulfoxides including two linear alkyl groups containing from 1 to 6 carbon atoms,
wherein the weight ratio of component a) to component b) is at least 25:75 and up to 99.9:0.1.

18. The composition in accordance with claim 17 wherein the high boiling additive is dimethyl sulfoxide (DMSO).

19. The composition in accordance with claim 17 wherein the high boiling additive is dimethyl sulfoxide (DMSO) and the electrically conductive polymer is PEDOT/PSS.

20. A composition suitable for the manufacture of films, the composition comprising, in a solvent preparation
a) at least one non-tubular graphene material which is an expanded graphite,
b) at least one electrically conductive polymer which is selected from polythiophenes and derivatives and,
c) at least one additive having a boiling point of at least 100° C. under atmospheric pressure,
wherein the weight ratio of component a) to component b) is at least 25:75 and up to 99.9:0.1.

21. The composition in accordance with claim 20 wherein the expanded graphite is obtained by flash thermal expansion of an expandable graphite.

22. A method for obtaining the composition according to claim 20, which comprises subjecting a dispersion comprising the non-tubular graphene material to a sonication treatment wherein the sonication treatment time ranges from 30 to 120 min.

23. The method of claim 22, wherein the sonication treatment time does not exceed 60 min.

24. A method for obtaining the composition according to claim 21, which comprises subjecting a dispersion comprising the non-tubular graphene material to a sonication treatment wherein the sonication treatment time does not exceed 60 min.

25. The method of claim 24, wherein the sonication treatment time is of at least 5 min.
